(19) United States
(12) Patent Application Publication
(10) Pub. No.: US 2026/0243227 A1
(43) Pub. Date: Aug. 20, 2026

(54) HYBRID TURBINE

(71) Applicants: Cevdet KOSE, Antalya (TR); Hayrettin GUMUSKAYA, Istanbul (TR)

(72) Inventors: Cevdet KOSE, Antalya (TR); Hayrettin GUMUSKAYA, Istanbul (TR)

(21) Appl. No.: 18/876,677

(22) PCT Filed: May 31, 2023
(86) PCT No.: PCT/TR2023/050500

§ 371 Date: Dec. 19, 2024

(30) Foreign Application Priority Data
Jul. 24, 2022 (TR) 2022/011739

(51) Int. Cl. F03D 9/00; F03D 3/00

(52) U.S. Cl. CPC F03D 9/007; F03D 3/009; F05B 2220/708

(57) ABSTRACT

A hybrid turbine is provided, which is manufactured in different sizes and dimensions as vertical and circular shapes and to a turbine which converts wind and solar energy into electricity simultaneously by cladding the blades, nacelle and frame parts of these turbines with panels made of solar cells. The turbine blades, nacelle and frame parts, briefly all the surfaces exposed to the outdoors, are cladded with solar cells, and its ability to convert the wind power and solar energy. The turbine is vertical and circular turbines manufactured in different sizes and dimensions, wherein the blade, nacelle and frame parts of these turbines are cladded with panels of solar cells, thereby allowing them to convert wind and solar energy into electricity simultaneously. All these structures are installed either on a mast or on a platform to create a working environment.

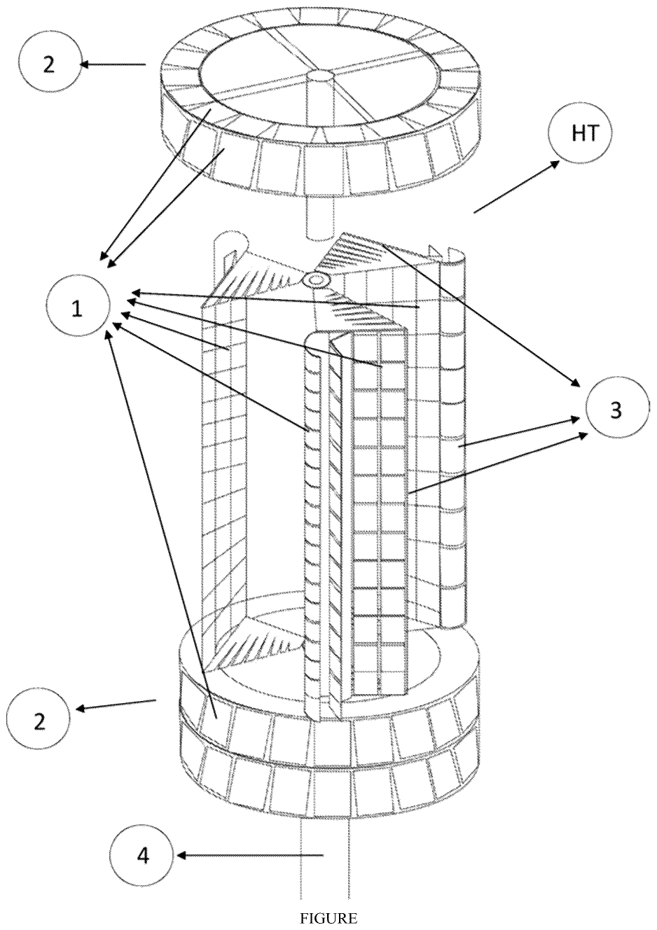

### CROSS REFERENCE TO THE RELATED APPLICATIONS

This application is the national phase entry of International Application No. PCT/TR2023/050500, filed on May 31, 2023, which is based upon and claims priority to Turkish Patent Application No. 2022/011739, filed on Jul. 24, 2022, the entire contents of which are incorporated herein by reference.

### TECHNICAL FIELD

The present invention relates to a turbine manufactured in different sizes and dimensions as vertical and circular shapes and to a turbine which converts wind and solar energy into electricity simultaneously by cladding the blades, nacelle and frame parts of these turbines with panels made of solar cells.

### BACKGROUND

Today, there are many devices and turbines that generate electricity using wind power. These turbines are manufactured and used in different sizes and with different materials and techniques based on their production capacity. However, none of the existing turbines is capable of generating electricity by utilising wind and solar energy simultaneously. Existing applications mainly include the following deficiencies.
a) Based on the shape and model in which they are built, they can only generate electricity with the energy they draw from wind power. Nevertheless, these turbines absorb as much sunlight as the space they occupy, and such energy can never be utilised.
b) The turbines that rotate in parallel to the ground when they are vertical are able to utilise the wind power from all directions compared to vertically positioned and vertically rotating turbines, and since they rotate uninterruptedly, they are always exposed to the sun proportional to their rotational speed. However, a model that can turn this advantage into yield has not been developed yet.

These deficiencies make the generation of electricity from the wind more expensive and inefficient.

### SUMMARY

The turbine, the subject of our invention, can be manufactured from many different materials in different sizes and dimensions. The turbine blades, nacelle and frame parts, briefly all the surfaces exposed to the outdoors, are cladded with solar cells, which eliminates all the deficiencies and problems mentioned above due to its ability to convert wind power and solar energy into electricity simultaneously. Regardless of the direction of the wind and the location of the sun, the constant use of these two different power sources together, i.e., hybrid operation, has allowed the highest yield to be achieved in very narrow spaces at low costs.

### BRIEF DESCRIPTION OF THE DRAWINGS

The FIGURE—Opposite view of the hybrid turbine (HT)

### DETAILED DESCRIPTION OF THE EMBODIMENTS

The parts in the FIGURE are enumerated and described below.

| ELEMENT | | FUNCTION AND CHARACTERISTIC OF THE |
|---|---|---|
| NO | ELEMENT NAME | ELEMENT |
| 1 | Solar cells on turbine | Cells that convert light energy from the sun into |
| | surfaces | electricity. |
| 2 | Top and bottom turbine | Frame structures that enable the blades to be fitted to the |
| | covers and frame | turbine and the main structure to stand. |
| | systems | |
| 3 | Turbine Blades | They are the main parts that gain rotational force by |
| | | using wind power and transfer it to the motor that |
| | | generates electricity and carry solar cells on it. |
| 4 | Turbine mast or bearing | A mast or platform made of any kind of material on |
| | Platform | which turbines are installed. |
| HT | Hybrid Turbine | A system that can be manufactured in many different sizes |
| | | and dimensions and generates electricity by using wind and |
| | | solar sources simultaneously. |

### DESCRIPTION OF THE INVENTION

The invention consists of vertical and circular turbines (HT) manufactured in different sizes and dimensions, wherein the blade (3), nacelle and frame parts (2) of these turbines are cladded with panels of solar cells (1), thereby allowing them to convert wind and solar energy into electricity simultaneously. All these structures are installed either on a mast or on a platform (4) to create a working environment.

### INDUSTRIAL APPLICATIONS OF THE INVENTION

The turbines, manufactured from different materials in different sizes and dimensions, are cladded with solar cells of different sizes and flexibilities, and are a device that allows the generation of electricity with high efficiency by using two different power sources simultaneously. The raw materials and components that are used during its production are easily available on the market. The turbine allows us to generate renewable energy, the need of today, independently as a hybrid.

What is claimed is:

1. A hybrid turbine (HT), comprising a blade, nacelle and frame parts, vertical and circular turbines, and solar cells, wherein wind and solar energy, as two different power sources, are converted into electricity simultaneously by cladding the blade, the nacelle and frame parts of the vertical and circular turbines manufactured in first different sizes and different dimensions with the solar cells of second different sizes and different flexibility.

2. The HT according to claim 1, wherein the blade, the nacelle and frame parts of the vertical and circular turbines manufactured in the first different sizes and the different dimensions are cladded with the solar cells of the second different sizes and the different flexibility wherein the HT is allowed for converting the wind and solar energy, as the two different power sources, into the electricity simultaneously.
